(19) United States
(12) Patent Application Publication
(10) Pub. No.: US 2015/0266134 A1
(43) Pub. Date: Sep. 24, 2015

(54) FIBER LASER PROCESSING MACHINE, FIBER CONNECTION METHOD AND FIBER LASER OSCILLATOR

(71) Applicants: KOMATSU INDUSTRIES CORPORATION, Kanazawa-shi, Ishikawa (JP); KOMATSU LTD., Tokyo (JP); FURUKAWA ELECTRIC CO., LTD., Tokyo (JP)

(72) Inventor: Seiichi Hayashi, Komatsu-shi (JP)

(21) Appl. No.: 14/434,423

(22) PCT Filed: Oct. 24, 2013
(86) PCT No.: PCT/JP2013/078802

§ 371 Date: Apr. 9, 2015

(30) Foreign Application Priority Data
Oct. 26, 2012 (JP) 2012-237300

(51) Int. Cl. B23K 26/38; G02B 6/255; B23K 26/06; G02B 6/42; B23K 26/08

(52) U.S. Cl. CPC B23K 26/38; G02B 6/4296; B23K 26/0807; B23K 26/06; G02B 6/255

(57) ABSTRACT

There is provided a fiber laser processing machine, a fiber connection method and a fiber laser oscillator that are capable of improving the beam quality. A fiber laser processing machine comprises: a processing machine body provided with a laser processing head for emitting laser beams; a fiber laser oscillator including a fiber laser module for generating the laser beams and a feeding fiber cable for collectively taking out the laser beams generated by the fiber laser module; and a process fiber cable for transmitting the laser beams taken out by the feeding fiber cable of the fiber laser oscillator to the laser processing head of the processing machine body. The feeding fiber cable and the process fiber cable are joined by fusion, and the feeding fiber cable and the process fiber cable have an equal core diameter.

### TECHNICAL FIELD

The present invention relates to a fiber laser processing machine as well as a fiber connection method and a fiber laser oscillator used in the fiber laser processing machine.

### BACKGROUND ART

A fiber laser processing machine is an apparatus for performing processing such as cutting of a workpiece by emitting laser beams onto the workpiece. In a conventional fiber laser processing machine, a fiber laser oscillator includes a plurality of fiber laser modules for generating laser beams and a feeding fiber cable for collectively taking out the laser beams generated by the plurality of fiber laser modules, and the feeding fiber cable is connected, by a coupling unit, to a process fiber cable for transmitting the laser beams to a processing head.

PTD 1 describes the following four points as disadvantages in the case of using this coupling unit.

(a) in the coupling unit, a collimator lens and a focusing lens are used to transmit the laser beams from the feeding fiber cable to the process fiber cable. Therefore, there is an aberration in laser beams caused by the lenses, which results in a reduction in output.

(b) A core diameter of the process fiber cable is larger than a core diameter of the feeding fiber cable, and thus, the luminance of the laser beams is reduced when the laser beams are transmitted.

(c) The coupling unit has an influence on the size of the fiber laser oscillator and it is difficult to reduce the size of the fiber laser oscillator.

(d) The laser beams are transmitted through the collimator lens and the focusing lens, and thus, adjustment thereof is difficult.

In order to solve the foregoing, PTD 1 proposes fixing the feeding fiber cable and the process fiber cable within a cylindrical body made of glass, with a laser beam emission end of the feeding fiber cable facing a laser beam incidence end of the process fiber cable with a prescribed gap therebetween.

As another solution, fusing the feeding fiber cable and the process fiber cable is also under study. PTD 1 describes that in either method, the core diameter of the feeding fiber cable is approximately 50 and the core diameter of the process fiber cable is approximately 100 to 200 μm, which is larger than the core diameter of the feeding fiber cable.

### CITATION LIST

### Patent Document

PTD 1: Japanese Patent Laying-Open No. 2012-27241

### SUMMARY OF INVENTION

### Technical Problem

However, PTD 1 describes that when the feeding fiber cable and the process fiber cable are fused, distortion of the shape of the cores in these cables occurs at a portion where heat is applied during fusion, which causes deterioration of the beam quality, and thus, the configuration described in PTD 1 cannot withstand the use in practice.

The present invention has been made in light of the aforementioned problems and an object of the present invention is to provide a fiber laser processing machine, a fiber connection method and a fiber laser oscillator that are capable of improving the beam quality.

### Solution to Problem

In order to increase the cutting speed of the fiber laser processing machine, the inventors of the present invention first considered increasing a power density PD (line density) expressed by the following equation (a), which has a proportional relationship with the cutting speed.

PD=P/(d×ρ) (a)

where P represents a power, d represents a spot diameter (focal point diameter), and power density PD represents power per unit area.

In order to increase power density PD, increasing power P is conceivable. However, when the power is increased, the consumed electric power increases and the running cost increases. Therefore, the inventors of the present invention considered decreasing spot diameter d. Spot diameter d is expressed by the following equation (b). FIG. 13 is a schematic view schematically showing an external optical system.

d=(α×M×λ×fL)/D

=(β×M×λ×fL)/fC (b)

where α and β represent coefficients, M represents a laser spread angle (beam mode), λ represents a wavelength of a laser beam, fL represents a focal length of a condenser lens, and fC represents a focal length of a collimator lens.

In order to decrease spot diameter d, decreasing focal length fL of the condenser lens or increasing focal length fC of the collimator lens is conceivable. However, due to a restriction of mechanical dimension, it is difficult to decrease focal length fL of the condenser lens, and due to a restriction of lens diameter of the collimator lens, it is difficult to increase focal length fC of the collimator lens. Thus, in order to decrease spot diameter d, the inventors of the present invention considered decreasing laser spread angle M which is also referred to as “beam mode”. As is also described in PTD 1, according to the conventional idea, the limit of the core diameter of the feeding fiber cable is approximately 50 μm and the limit of the core diameter of the process fiber cable is approximately 100 to 200 μm, which is larger than the core diameter of the feeding fiber cable, from the perspective of connecting the cables, and decreasing the core diameter of the process fiber cable to be smaller than 100 μm has not been conceived. Furthermore, fusion of the feeding fiber cable and the process fiber cable has not been recognized as a realistic connection method, either.

The present invention has achieved improvement in beam quality by fusion of the feeding fiber cable and the process fiber cable, which has been conventionally regarded as unrealistic. The present invention provides the following aspects.

(1) A fiber laser processing machine comprising:

a processing machine body provided with a laser processing head for emitting laser beams;

a fiber laser oscillator including a fiber laser module for generating the laser beams and a feeding fiber cable for collectively taking out the laser beams generated by the fiber laser module; and

a process fiber cable for transmitting the laser beams taken out by the feeding fiber cable of the fiber laser oscillator to the laser processing head of the processing machine body, wherein

the feeding fiber cable and the process fiber cable are joined by fusion, and

the feeding fiber cable and the process fiber cable have an equal core diameter.

(2) The fiber laser processing machine according to (1), wherein each of the feeding fiber cable and the process fiber cable has a uniform core diameter.

(3) The fiber laser processing machine according to (1) or (2), wherein the fiber laser oscillator includes a casing that houses the fiber laser module and the feeding fiber cable, and

a fused portion of the feeding fiber cable and the process fiber cable is arranged on a drawable fusion table housed in the casing.

(4) The fiber laser processing machine according to (3), wherein the processing machine body includes a cabin that houses the laser processing head and forms an external shape of the processing machine body, and

the cabin includes, at a side surface, an oscillator housing portion that houses the fiber laser oscillator, and the fiber laser oscillator is housed in the oscillator housing portion in a state of the casing.

(5) A fiber connection method used in a fiber laser processing machine comprising: a fiber laser oscillator including a fiber laser module for generating laser beams and a feeding fiber cable for collectively taking out the laser beams generated by the fiber laser module; and a process fiber cable for transmitting the laser beams taken out by the feeding fiber cable to a laser processing head, the fiber connection method being for connecting the feeding fiber cable and the process fiber cable, wherein

fusion is performed on a drawable fusion table provided in a casing of the fiber laser oscillator.

(6) A fiber laser oscillator comprising:

a fiber laser module for generating laser beams;

a feeding fiber cable for collectively taking out the laser beams generated by the fiber laser module; and

a casing that houses the fiber laser module and the feeding fiber cable,

the fiber laser oscillator being connected to a process fiber cable for transmitting the laser beams to a laser processing head, wherein

the feeding fiber cable and the process fiber cable are joined by fusion, and

a fused portion of the feeding fiber cable and the process fiber cable is arranged on a fusion table housed in the casing in a drawable manner.

### Advantageous Effects of Invention

According to the aspect described in (1) above, the feeding fiber cable and the process fiber cable are connected by fusion. Therefore, the process fiber cable having the core diameter equal to the core diameter of the feeding fiber cable can be used, and a reduction in luminance caused by a difference in core diameter can be suppressed, and the beam quality can be improved. In addition, due to fusion, the core diameter of the process fiber cable can be made smaller than that of a conventional process fiber cable, and the laser spread angle (BPP: Beam Parameter Product) which is also referred to as “beam mode” can be decreased, and the cutting speed can be increased.

According to the aspect described in (2) above, a reduction in luminance caused by a difference in core diameter can be suppressed and the beam quality can be improved, without providing any special processing to the feeding fiber cable and the process fiber cable.

According to the aspect described in (3) above, the fusion treatment for the feeding fiber cable and the process fiber cable becomes easy. The fusion treatment, which is normally performed in a clean room of a factory and the like, can be performed at a site where the fiber laser processing machine is assembled, at a site where the fiber laser processing machine is placed, or the like. As a result, at the time of replacement and the like of the process fiber cable, the fusion table is drawn out from the casing of the fiber laser oscillator, and thereby, the fusion treatment can be easily performed.

According to the aspect described in (4) above, as compared with the case of placing the fiber laser oscillator at a distance from the fiber laser processing machine body, the fiber laser processing machine is well integrated, and the entire size of the fiber laser processing machine can be reduced because the fiber laser oscillator can be housed in the cabin of the processing machine body. In addition, the fiber laser oscillator and the fiber laser processing machine body can be conveyed together, with the feeding fiber cable and the process fiber cable fused.

According to the aspects described in (5) and (6) above, the fusion treatment for the feeding fiber cable and the process fiber cable becomes easy. The fusion treatment, which is normally performed in a clean room of a factory and the like, can be performed at a site where the fiber laser processing machine is assembled, at a site where the fiber laser processing machine is placed, or the like. As a result, at the time of replacement and the like of the process fiber cable, the fusion table is drawn out from the casing of the fiber laser oscillator, and thereby, the fusion treatment can be easily performed.

### BRIEF DESCRIPTION OF DRAWINGS

FIG. 1 is a cross-sectional view showing a fiber connection structure according to one embodiment of the present invention.

FIG. 2 is a schematic plan view of a laser processing machine according to one embodiment of the present invention.

FIG. 3 is a schematic side view of the laser processing machine shown in FIG. 2.

FIG. 4 is a perspective view of a processing head drive mechanism.

FIG. 5 is a perspective view of a processing head.

FIG. 6 is a back view of the laser processing machine shown in FIG. 2.

FIG. 7 is a perspective view of the right side surface side of the laser processing machine shown in FIG. 2.

FIG. 8 is a perspective view of the left side surface side of the laser processing machine shown in FIG. 2.

FIG. 9 is a perspective view showing a state in which a door of a laser oscillator is open.

FIG. 10 is a view showing the inside of a fusion box.

FIG. 11 is a graph showing the upper limit cutting speed with respect to a plate thickness in each fiber laser processing machine.

FIG. 12 is a graph showing the upper limit cutting speed in each fiber laser processing machine, and FIG. 12(a) is a graph when the plate thickness is 1 mm and FIG. 12(b) is a graph when the plate thickness is 2 mm.

FIG. 13 is a schematic view schematically showing an external optical system.

### DESCRIPTION OF EMBODIMENTS

One embodiment of a fiber connection structure according to the present invention will be described first.

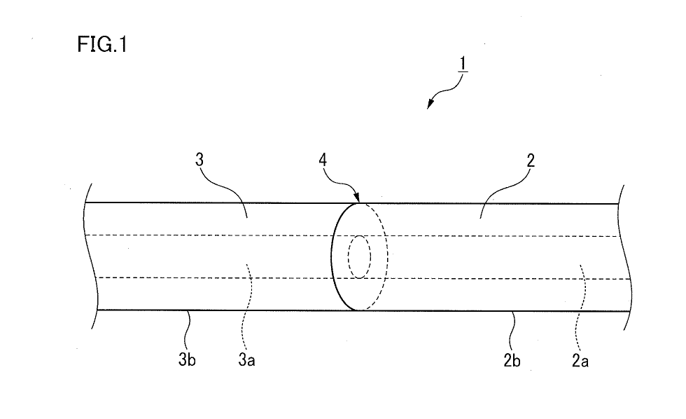

A fiber connection structure 1 according to the present embodiment is applied to, for example, a fiber laser processing machine 10 described below, and as shown in FIG. 1, a feeding fiber cable 2 and a process fiber cable 3 having the same core diameter are connected by fusion. In FIG. 1, 2a represents a core of feeding fiber cable 2, 2b represents a clad of feeding fiber cable 2, 3a represents a core of process fiber cable 3, 3b represents a clad of process fiber cable 3, and 4 represents a fused portion. In the present specification, when a difference in core diameter between the two fiber cables is equal to or less than ±10%, these two fiber cables are regarded as having the same core diameter. For example, when the core diameter of feeding fiber cable 2 is 50 μm, feeding fiber cable 2 and process fiber cable 3 are regarded as having the same core diameter and the respective core diameters are regarded as being equal if the core diameter of process fiber cable 3 is within the range of 50±5 μm.

Feeding fiber cable 2 and process fiber cable 3 having the equal core diameter are fused as described above, and thus, a reduction in luminance caused by a difference in core diameter between both cables 2 and 3 is suppressed and the beam quality is improved. In addition, the coupling unit is eliminated, and thus, there is no aberration in laser beams caused by the collimator lens and the focusing lens, which makes it possible to avoid a reduction in output, an increase in size of the apparatus caused by the coupling unit, and complication of lens adjustment.

Feeding fiber cable 2 and process fiber cable 3 may have the same core diameter only at a fused portion 4. It is, however, preferable that each of feeding fiber cable 2 and process fiber cable 3 has a uniform core diameter. Thus, a reduction in luminance caused by a difference in core diameter can be suppressed and the beam quality can be improved, without providing any special processing to feeding fiber cable 2 and the process fiber cable. In the present specification, when a distribution of the core diameter of the fiber cable is within the range of ±10% or less, this fiber cable is regarded as having a uniform core diameter. For example, when feeding fiber cable 2 (or process fiber cable 3) has a core diameter of 50±5 μm over the entire length thereof, feeding fiber cable 2 (or process fiber cable 3) is regarded as having a uniform core diameter.

The fusion treatment is performed by arranging feeding fiber cable 2 and process fiber cable 3 such that end faces thereof face each other, and heating feeding fiber cable 2 and process fiber cable 3 with both end faces abutting each other. This fusion treatment can be performed by using an optical fiber fusion splicer. It is, however, preferable to perform the fusion treatment by using a core-direct-view-type optical fiber fusion splicer which is excellent in centering capability. By using the optical fiber fusion splicer to perform the fusion treatment, process fiber cable 3 having the core diameter smaller than that of a conventional process fiber cable can be used. Since cables 2 and 3 having the small core diameters are connected, laser spread angle M can be decreased and the cutting speed can be increased.

The core diameter of each of feeding fiber cable 2 and process fiber cable 3 is preferably about 100 μm or smaller, and more preferably about 50 μm or smaller. A clad diameter is not particularly limited, and feeding fiber cable 2 and process fiber cable 3 may have different clad diameters or the same clad diameter.

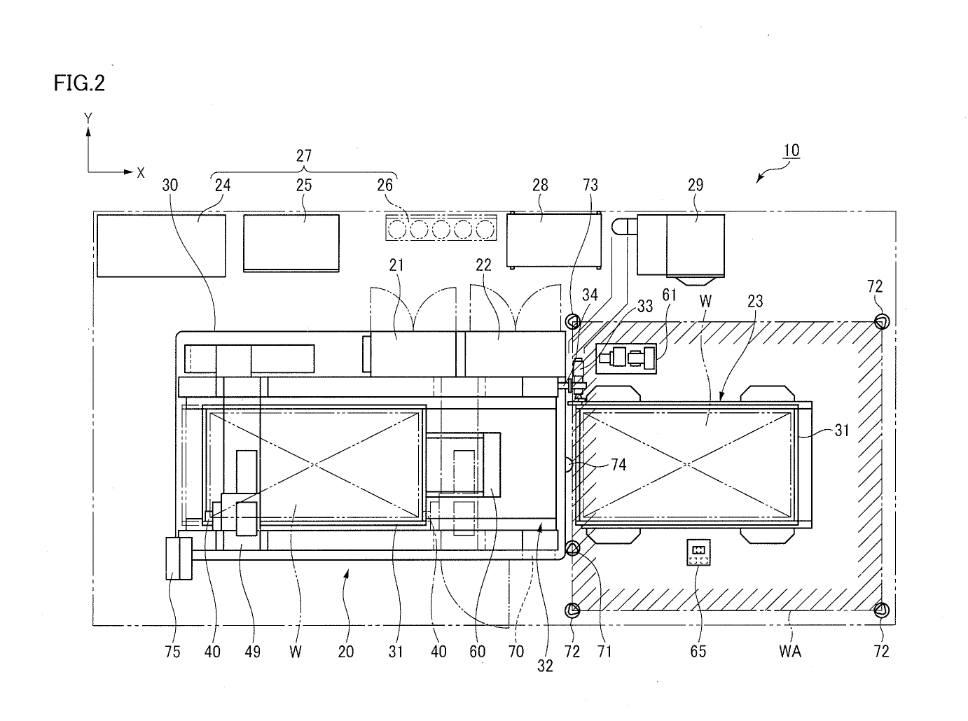

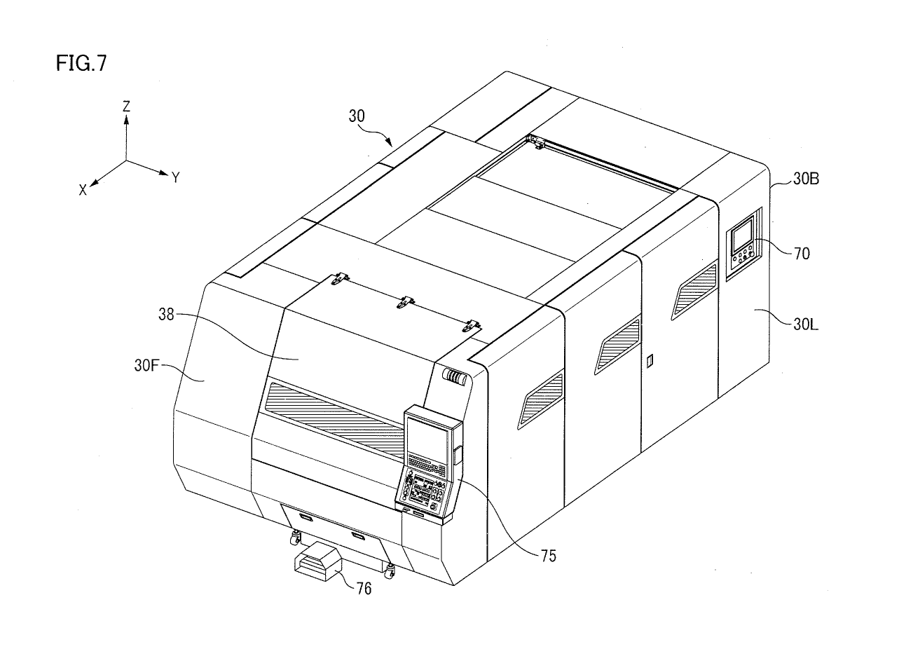

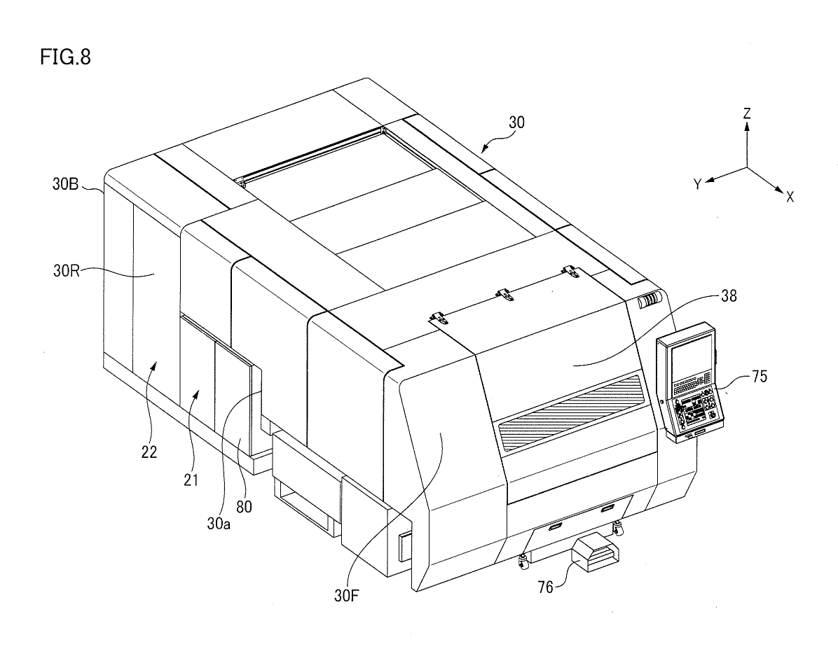

Next, a fiber laser processing machine to which fiber connection structure 1 according to the present invention is applied as well as a fiber laser oscillator will be described with reference to FIGS. 2 to 10.

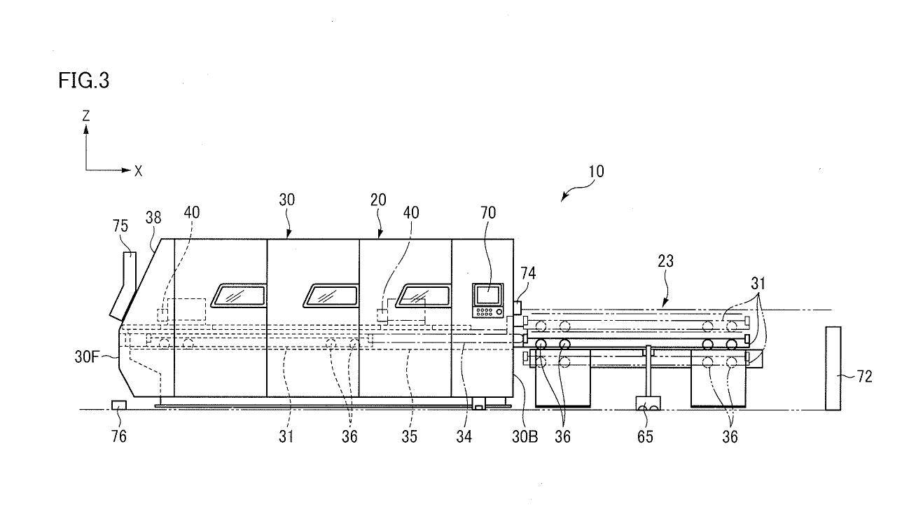

As shown in FIGS. 2 and 3, a fiber laser processing machine 10 (hereinafter referred to as “laser processing machine”) mainly includes a processing machine body 20, a fiber laser oscillator 21 (hereinafter referred to as “laser oscillator”) and a control device 22 connected to processing machine body 20, a pallet changer 23 disposed to be connected to processing machine body 20, an assist gas supply portion 27 including a booster compressor 24 and an air compressor 25 used to separate a nitrogen gas in the air, or an oxygen gas cylinder 26 and the like, a chiller unit 28 for supplying cooling water that cools laser oscillator 21 and a laser processing head 40 (hereinafter referred to as “processing head”), and a dust collector 29 for removing dust and the like that occur during processing.

In the present embodiment, “frontward” refers to a direction closer to processing machine body 20 in a direction of arrangement of processing machine body 20 and pallet changer 23 (in the X direction in FIG. 2), and “rearward” refers to a direction closer to pallet changer 23 in this direction of arrangement. In addition, “leftward” and “rightward” are expressed by directions when viewing the frontward from the rearward in a direction orthogonal to the direction of arrangement (in the Y direction in FIG. 2).

Housed in a cabin 30 that forms a part of processing machine body 20 and forms an external shape of processing machine body 20 are a pallet drive mechanism 32 for driving a pallet 31 in a prescribed direction, i.e., in a longitudinal direction (X direction) of cabin 30, processing head 40 for emitting laser beams for processing a workpiece W mounted on pallet 31, a processing head drive mechanism 49 for driving processing head 40, and a collection conveyor 60 for collecting scraps and the like cut during processing.

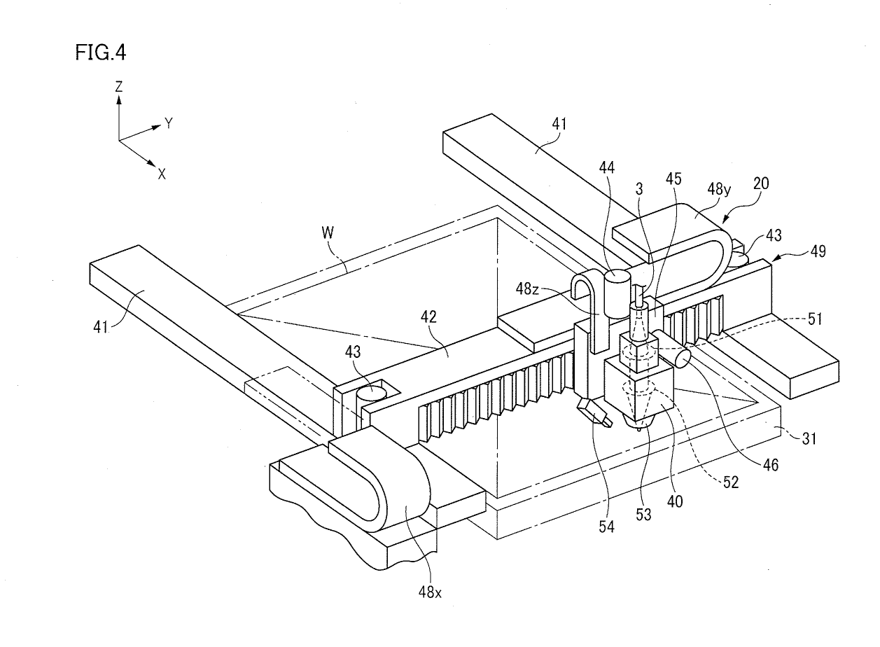

As shown in FIG. 4, processing head 40 is provided in processing machine body 20 and is movable in the X direction, in a width direction (Y direction) of cabin 30, and in a vertical direction (Z direction) of cabin 30 by processing head drive mechanism 49. Specifically, a beam-like X-direction movable platform 42 is arranged to span a pair of support platforms 41 provided right and left, and this X-direction movable platform 42 is driven in the X direction by an X-axis motor 43. A Y-direction movable platform 45 that is driven by a Y-axis motor 44 and is movable in the Y direction is also disposed at X-direction movable platform 42. Y-direction movable platform 45 is driven in the Y direction by a rack and pinion mechanism for meshing a not-shown pinion fixed to a rotation shaft of Y-axis motor 44 with a not-shown rack arranged in X-direction movable platform 42. In addition, by using a rack and pinion mechanism driven by a Z-axis motor 46, processing head 40 is disposed at Y-direction movable platform 45 so as to be movable in the Z direction.

Processing head 40 shown by a solid line in FIG. 2 and a dotted line in FIG. 3 indicates a state of being located at the most frontward part in the X direction (a position where pallet 31 is placed during processing), and processing head 40 shown by an alternate long and short dash line in FIGS. 2 and 3 indicates a state of being located at the most rearward part in the X direction.

A process fiber cable (only a tip thereof is shown) 3 extending from laser oscillator 21 is routed through an X-direction cableveyor (registered trademark) 48x and a Y-direction cableveyor (registered trademark) 48y, and is connected to processing head 40. Also arranged in processing head 40 are a collimator lens 51 for parallelizing the laser beams emitted from an emission end of process fiber cable 3, and a condenser lens 52 for condensing the parallelized laser beams. Condenser lens 52 is provided such that a position thereof can be freely adjusted in the Z direction with respect to processing head 40.

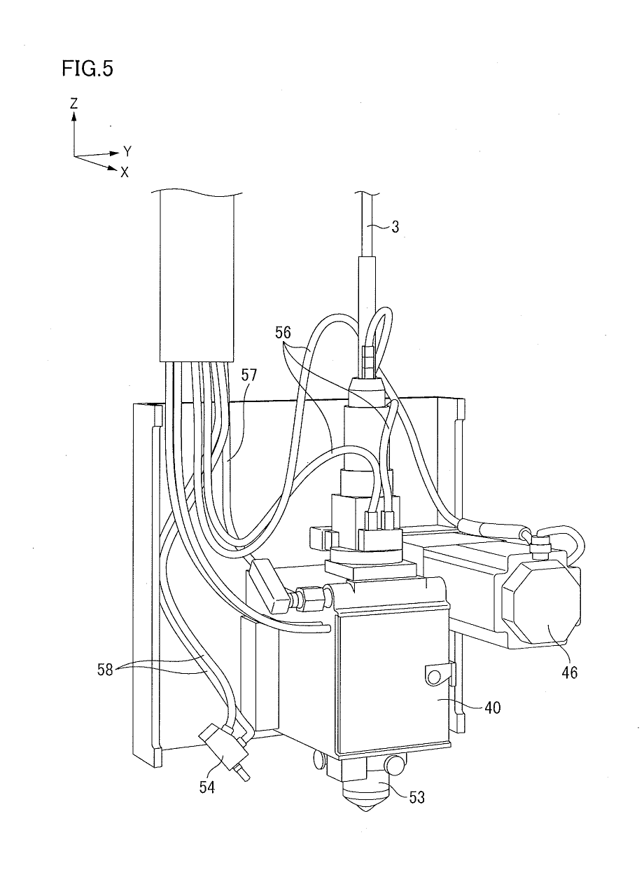

As shown in FIG. 5, a cooling pipe 56 provided from chiller unit 28 is connected around processing head 40 to cool the emission end of process fiber cable 3 and the surroundings of condenser lens 52. Furthermore, provided around processing head 40 are a gas supply pipe 57 for supplying an assist gas such as a nitrogen gas or an oxygen gas from assist gas supply portion 27 into processing head 40, and a gas supply pipe 58 connected to a side nozzle 54 for spraying the assist gas such as the nitrogen gas or the oxygen gas toward the neighborhood of a laser nozzle 53 of processing head 40.

These cooling pipe 56 and gas supply pipes 57 and 58 pass through a Z-direction cableveyor (registered trademark) 48z, and then, are routed to X-direction cableveyor (registered trademark) 48x and Y-direction cableveyor (registered trademark) 48y, together with process fiber cable 3, and are connected to chiller unit 28 and assist gas supply portion 27.

When laser oscillator 21 is actuated, the laser beams pass through process fiber cable 3 and are parallelized by collimator lens 51. Further, the parallelized laser beams enter condenser lens 52 to be condensed, and are emitted from laser nozzle 53 to a portion of workpiece W to be processed, and processing head 40 processes workpiece W. During processing, the assist gas supplied from assist gas supply portion 27 is injected from laser nozzle 53 and side nozzle 54 toward the portion of workpiece W to be processed, such that the molten metal generated during processing is blown away.

As shown in FIGS. 2 and 3, pallet drive mechanism 32 is disposed at a position facing a right side surface of pallet 31 along the X direction, and has an endless chain 34 rotationally driven by a drive motor 33, and a rail 35 on which a plurality of rollers 36 provided on the lower surface side of pallet 31 are guided in a rolling manner and which supports pallet 31. When endless chain 34 is rotationally driven by drive motor 33, a pin (not shown) provided at endless chain 34 engages with an engagement portion (not shown) of pallet 31 and pallet 31 on rail 35 is moved in the X direction.

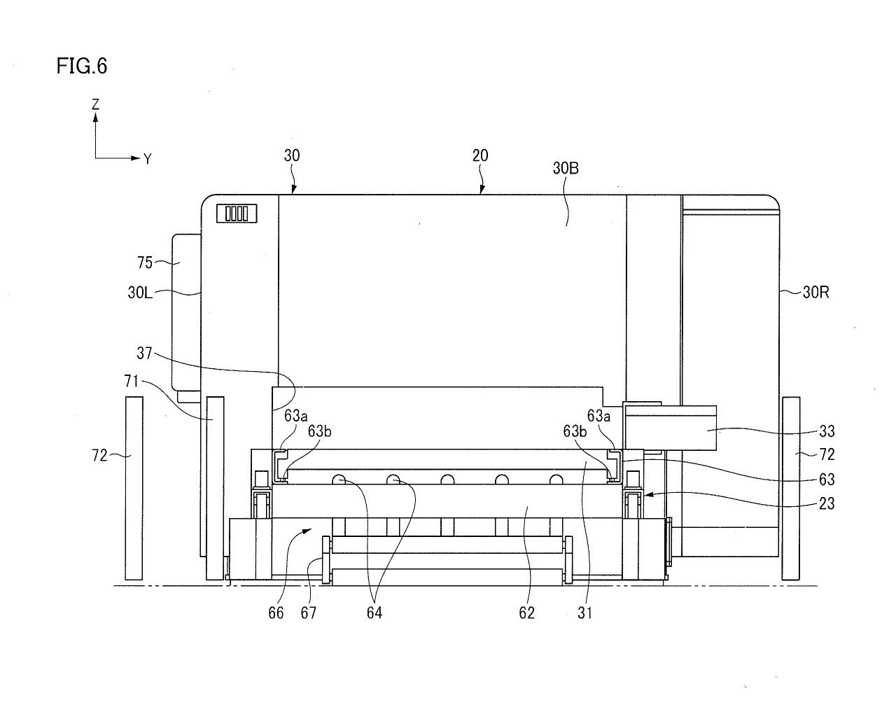

As shown in FIGS. 6 to 8, a gull wing 38 which is an open/close door is provided on a front surface 30F of cabin 30, and on a rear surface 30B which is the opposite side of front surface 30F, a loading/unloading port 37 formed in the shape of a horizontally long slit is provided to correspond to pallet changer 23. Thus, at the time of processing of large-lot products, pallet 31 having workpiece W placed thereon is loaded/unloaded through loading/unloading port 37, and at the time of processing of small-lot products, workpiece W is loaded/unloaded from gull wing 38. As a result, the loading/unloading operation corresponding to the lot size can be performed.

On front surface 30F of cabin 30, a first control panel 75 is also arranged at a lateral part of gull wing 38. On a left side surface 30L, a second control panel 70 is arranged closer to rear surface 30B. Furthermore, a foot switch 76 that can be foot-operated by the operator is arranged at front surface 30F of cabin 30 and below gull wing 38.

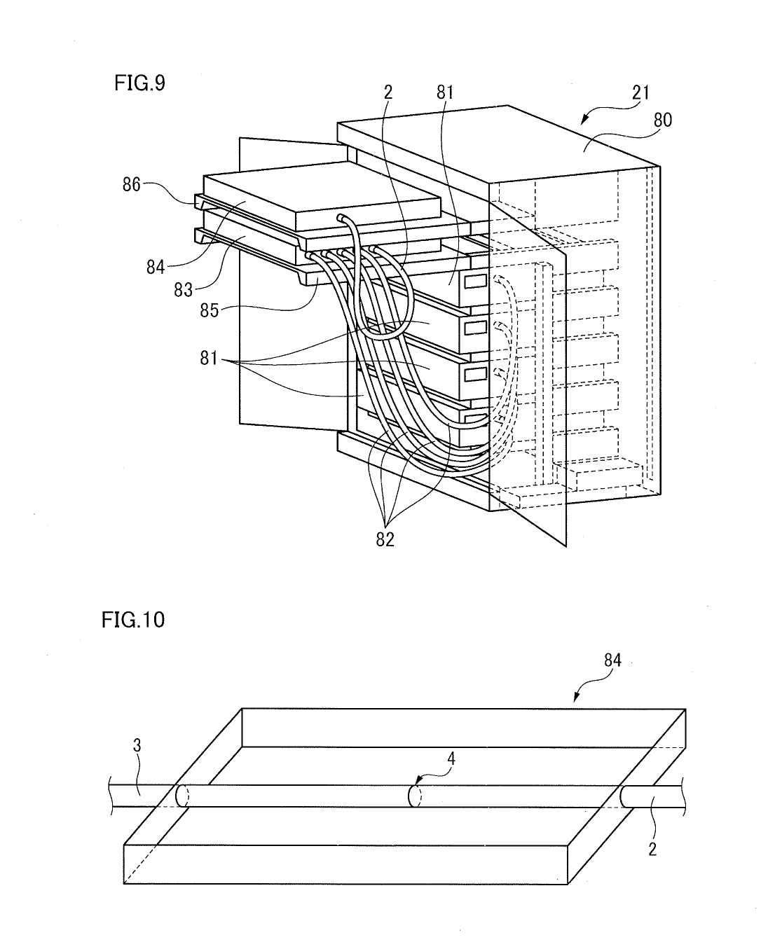

A concave oscillator housing portion 30a that houses laser oscillator 21 is arranged at a substantially central portion of a right side surface 30R of cabin 30. As shown in FIG. 9, laser oscillator 21 arranged in this oscillator housing portion 30a is configured such that, in a box-type casing 80, a plurality of (four in the present embodiment) fiber laser modules 81 for generating laser beams are vertically stacked and housed, and a combiner 83 having an output cable 82 from each fiber laser module 81 connected thereto is housed above fiber laser modules 81. Furthermore, a fusion box 84 connected to combiner 83 by feeding fiber cable 2 is housed above combiner 83.

As shown in FIG. 10, process fiber cable 3 connecting to processing head 40 is inserted into fusion box 84 on the opposite side of the side into which feeding fiber cable 2 is inserted, and fused portion 4 of feeding fiber cable 2 and process fiber cable 3 is arranged in fusion box 84. Combiner 83 and fusion box 84 are arranged on a combiner table 85 and a fusion table 86 that can be drawn out from casing 80, respectively.

Referring again to FIGS. 2, 3 and 6, pallet changer 23 is arranged to face rear surface 30B of cabin 30 having loading/unloading port 37. Pallet changer 23 has a movable frame 62 driven upwardly and downwardly by a drive mechanism 61 shown in FIG. 2, and two pallets 31 can be arranged vertically in two stages on an angular substantially C-shaped rail 63 provided at right and left lateral parts of movable frame 62.

Upper pallet 31 is placed on an upper rail surface 63a of angular substantially C-shaped rail 63, and lower pallet 31 is placed on a lower rail surface 63b of angular substantially C-shaped rail 63. A height of pallets 31 arranged in two stages on angular substantially C-shaped rail 63 is adjustable such that when movable frame 62 is driven upwardly and downwardly by drive mechanism 61, pallets 31 on angular substantially C-shaped rail 63 can move upwardly and downwardly to come level with rail 35 disposed in cabin 30. Therefore, pallet 31 located at the same height as that of rail 35 can be loaded/unloaded between pallet changer 23 and the inside of cabin 30 through loading/unloading port 37.

A workpiece lifter 66 including, at a top portion thereof, a free bearing 64 for moving workpiece W on pallet 31 to cause workpiece W to align with a datum of pallet 31 is also provided below movable frame 62 such that workpiece lifter 66 can be moved up and down (see FIG. 6). In FIGS. 2 and 3, a reference character 65 represents a foot switch for actuating a drive mechanism 67 that drives workpiece lifter 66 upwardly and downwardly.

As shown in FIG. 2, a sensor including a photo transmitter 71, reflectors 72 and a photo receiver 73 is arranged at each corner of a working area WA enclosing pallet changer 23, and the light emitted from photo transmitter 71 is reflected by three reflectors 72 and received by photo receiver 73, thereby monitoring entrance and exit of the operator and the like into and from working area WA. An area sensor 74 is also disposed on rear surface 30B of cabin 30 to detect whether the operator and the like are in working area WA or not. When the sensor including photo transmitter 71, reflectors 72 and photo receiver 73 or area sensor 74 is actuated, it is determined that the operator and the like are in working area WA, and the loading/unloading operation by pallet changer 23 is prohibited, and thus, the safety of the operator and the like is ensured.

Fiber connection structure 1 according to the present embodiment is applicable to not only laser processing machine 10 described above but also various fiber laser processing machines. However, by applying fiber connection structure 1 to particularly laser processing machine 10 described above, fused portion 4 of feeding fiber cable 2 and process fiber cable 3 can be arranged on fusion table 86 that can be drawn out from casing 80 of laser oscillator 21. As a result, the fusion treatment for feeding fiber cable 2 and process fiber cable 3 becomes easy, and the fusion treatment, which is normally performed in a clean room of a factory and the like, can be performed at a site where laser processing machine 10 is assembled, at a site where laser processing machine 10 is placed, or the like. In other words, at the time of replacement and the like of process fiber cable 3, fusion table 86 is drawn out from casing 80 and a drawn-out portion is covered with a simple clean booth to form a simplified clean room, and thereby, the fusion treatment can be easily performed. Fusion table 86 and fusion box 84 may be formed integrally or separately.

In addition, combiner table 85 does not always need to be drawable from casing 80. However, by configuring combiner table 85 to be drawable similarly to fusion table 86, the work such as replacement, addition and the like of fiber laser module 81 can be easily performed.

In addition, in laser processing machine 10, laser oscillator 21 can be housed in oscillator housing portion 30a formed in right side surface 30R of cabin 30. Therefore, as compared with the case of placing the laser oscillator at a distance from processing machine body 20, laser processing machine 10 is well integrated, and the entire size of laser processing machine 10 can be reduced because laser oscillator 21 can be housed in cabin 30 of processing machine body 20. In addition, laser oscillator 21 and fiber laser processing machine body 20 can be conveyed together, with feeding fiber cable 2 and process fiber cable 3 fused.

### EXAMPLE

Examples of the present invention will be described hereinafter.

In order to demonstrate the effect of the fiber connection structure according to the present invention, the cutting speed (hereinafter referred to as “upper limit cutting speed”) in a range of not generating dross (so-called dross-free cutting) was measured by using a fiber laser processing machine having a power of 1 kW in which the fiber connection structure according to the present invention was used (Example 1), a fiber laser processing machine according to the present invention having a power of 2 kW (Example 2), a conventional fiber laser processing machine having a power of 2 kW (Comparative Example 1), a conventional fiber laser processing machine having a power of 4 kW (Comparative Example 2), and a carbon dioxide gas laser processing machine having a power of 2 kW (Comparative Example 3). For the measurement, thin plates made of SUS304 and having three types of plate thicknesses (t=1 mm, 2 mm and 3 mm) were used and cutting was performed linearly.

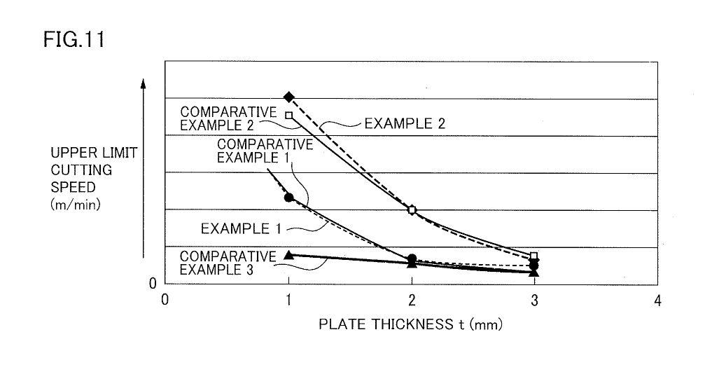

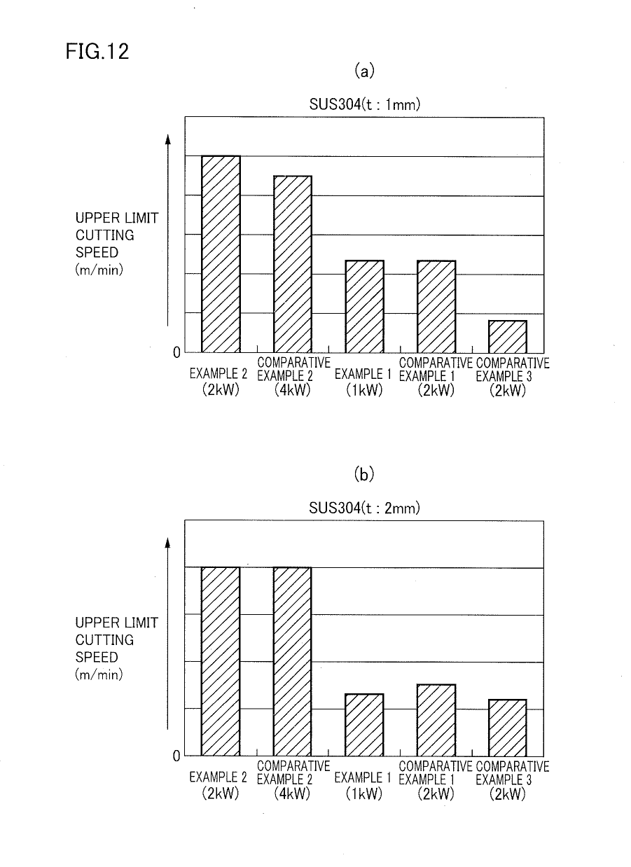

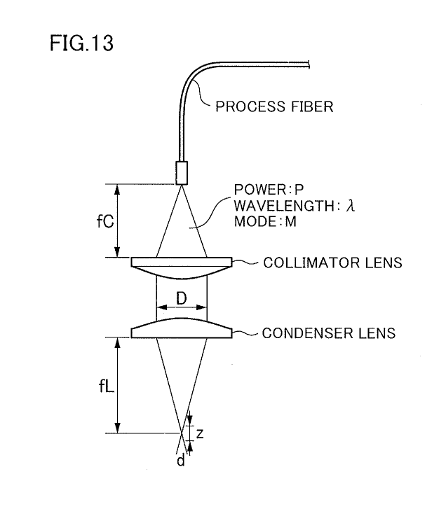

FIG. 11 is a graph showing the upper limit cutting speed with respect to the plate thickness in each fiber laser processing machine. FIG. 12(a) is a graph showing the upper limit cutting speed in each fiber laser processing machine when the plate thickness is 1 mm, and FIG. 12(b) is a graph showing the upper limit cutting speed in each fiber laser processing machine when the plate thickness is 2 mm.

As can be seen from FIG. 11, there was not so large difference in upper limit cutting speed when the plate thickness was 3 mm. However, as the plate thickness became smaller, a large difference was caused in upper limit cutting speed. As is clear from FIG. 12(b), when plate thickness t=2 mm, the fiber laser processing machine in Example 1 exhibited the upper limit cutting speed that was substantially the same level as those of the fiber laser processing machine in Comparative Example 1 and the carbon dioxide gas laser processing machine in Comparative Example 3 having twice the power. In addition, the fiber laser processing machine in Example 2 exhibited the upper limit cutting speed that was more than three times higher than those of the fiber laser processing machine in Comparative Example 1 and the carbon dioxide gas laser processing machine in Comparative Example 3 having the same power, and further, exhibited the upper limit cutting speed that was substantially the same level as that of the fiber laser processing machine in Comparative Example 2 having twice the power.

As is clear from FIG. 12(a), when plate thickness t=1 mm, the fiber laser processing machine in Example 1 exhibited the upper limit cutting speed that was the same level as that of the fiber laser processing machine in Comparative Example 1 having twice the power, and exhibited the upper limit cutting speed that was about three times higher than that of the carbon dioxide gas laser processing machine in Comparative Example 3 having twice the power. In addition, the fiber laser processing machine in Example 2 exhibited the upper limit cutting speed that was more than twice as high as that of the fiber laser processing machine in Comparative Example 1 having the same power, exhibited the upper limit cutting speed that was more than six times higher than that of the carbon dioxide gas laser processing machine in Comparative Example 3 having the same power, and further, exhibited the upper limit cutting speed higher than that of the fiber laser processing machine in Comparative Example 2 having twice the power.

Thus, particularly when a thin plate material of 2 mm or thinner was cut, the fiber laser processing machine in which the fiber connection structure according to the present embodiment was used exhibited the upper limit cutting speed that was significantly higher than those of the laser processing machine and the carbon dioxide gas laser processing machine having the same power, and exhibited the upper limit cutting speed that was substantially the same level as that of the laser processing machine having twice the power. This means that the fiber laser processing machine according to the present embodiment can perform the same cutting work in a shorter time than the laser processing machine having the same power due to a difference in upper limit cutting speed, and means that the fiber laser processing machine according to the present embodiment can perform the same cutting work with a smaller amount of consumed electric power than the laser processing machine having twice the power.

As described above, according to the present invention, feeding fiber cable 2 and process fiber cable 3 are connected by fusion. Therefore, process fiber cable 3 having the core diameter equal to the core diameter of feeding fiber cable 2 can be used, and a reduction in luminance caused by a difference in core diameter can be suppressed, and the beam quality can be improved. In addition, due to fusion, the core diameter of process fiber cable 3 can be made smaller than that of a conventional process fiber cable, and the laser spread angle which is also referred to as “beam mode” can be decreased, and the cutting speed can be increased.

The present invention is not limited to the aforementioned embodiment, and variation, modification or the like is possible as appropriate.

For example, the configuration of the inside of casing 80 of laser oscillator 21 is not limited to the aforementioned embodiment, and a plurality of fiber laser modules 81 may be arranged side by side. In addition, at least one fiber laser module 81 may only be housed and the number thereof can be changed as appropriate and a space for placing the module(s) may be made for subsequent addition.

### REFERENCE SIGNS LIST

1 fiber connection structure; 2 feeding fiber cable; 3 process fiber cable; 4 fused portion; 10 fiber laser processing machine; 20 processing machine body; 21 fiber laser oscillator; 30 cabin; 30a oscillator housing portion; 40 laser processing head; 80 casing; 81 fiber laser module; 86 fusion table.

1. A fiber laser processing machine comprising:
a processing machine body provided with a laser processing head for emitting laser beams;
a fiber laser oscillator including a fiber laser module for generating the laser beams and a feeding fiber cable for collectively taking out the laser beams generated by the fiber laser module; and
a process fiber cable for transmitting the laser beams taken out by the feeding fiber cable of the fiber laser oscillator to the laser processing head of said processing machine body, said feeding fiber cable being joined by fusion to said process fiber cable, and said feeding fiber cable having an equal core diameter to said process fiber cable.

2. The fiber laser processing machine according to claim 1, wherein each of said feeding fiber cable and said process fiber cable has a uniform core diameter.

3. The fiber laser processing machine according to claim 1, wherein
said fiber laser oscillator includes a casing that houses said fiber laser module and said feeding fiber cable, and
a fused portion of said feeding fiber cable and said process fiber cable is arranged on a drawable fusion table housed in said casing.

4. The fiber laser processing machine according to claim 3, wherein
said processing machine body includes a cabin that houses said laser processing head and forms an external shape of said processing machine body, and
said cabin includes, at a side surface, an oscillator housing portion that houses said fiber laser oscillator, and said fiber laser oscillator is housed in the oscillator housing portion in a state of said casing.

5. A fiber connection method used in a fiber laser processing machine comprising: a fiber laser oscillator including a fiber laser module for generating laser beams and a feeding fiber cable for collectively taking out the laser beams generated by the fiber laser module; and a process fiber cable for transmitting the laser beams taken out by said feeding fiber cable to a laser processing head, the fiber connection method being for connecting said feeding fiber cable and said process fiber cable, wherein
fusion is performed on a drawable fusion table provided in a casing of said fiber laser oscillator.

6. A fiber laser oscillator comprising:
a fiber laser module for generating laser beams;
a feeding fiber cable for collectively taking out the laser beams generated by the fiber laser module; and
a casing that houses said fiber laser module and said feeding fiber cable, the fiber laser oscillator being connected to a process fiber cable for transmitting the laser beams to a laser processing head, said process fiber cable being joined by fusion to said feeding fiber cable, and a fused portion of said feeding fiber cable and said process fiber cable being arranged on a fusion table housed in said casing in a drawable manner.
